(19) United States
(12) Patent Application Publication
(10) Pub. No.: US 2010/0200351 A1
(43) Pub. Date: Aug. 12, 2010

(54) MAGNETORHEOLOGICAL TORQUE TRANSMISSION DEVICE, THE USE THEREOF, AND MAGNETORHEOLOGICAL TORQUE TRANSMISSION METHOD

(75) Inventors: Holger Boese, Wuerzburg (DE); Johannes Ehrlich, Wiesenbronn (DE)

Correspondence Address: MARSHALL & MELHORN, LLC, FOUR SEAGATE - EIGHTH FLOOR, TOLEDO, OH, 43604, US

(73) Assignee: FRAUNHOFER-GESELLSCHAFT ZUR FOERDERUNG DER ANGEWANDTEN FORSCHUNG E.V., MUNICH (DE)

(21) Appl. No.: 12/450,871

(22) PCT Filed: Apr. 25, 2008
(86) PCT No.: PCT/EP2008/003385

§ 371 Date: Apr. 13, 2010

(30) Foreign Application Priority Data
Apr. 25, 2007 (DE) 10 2007 019 584.4

(51) Int. Cl. F16D 37/02

(52) U.S. Cl. 192/21.5

(57) ABSTRACT

The present invention relates to a magnetorheological torque transmission device. The same has two device parts rotatable relative to each other about a rotational axis (R) through a torque transmission gap (2), which can be filled and/or is filled at least partially with a magnetorheological material, and is characterized in that the magnetic circuit system of the torque transmission device configured for generating the magnetic flux in the torque transmission gap (2) comprises at least one permanent magnet (4) in addition to a solenoid (1). Advantageously said magnetic circuit system further comprises at least one non-magnetic insert (5, 6).

The present invention relates to a magnetorheological torque transmission device, use thereof and also to a corresponding magnetorheological torque transmission method. The magnetorheological torque transmission device can hereby be used in particular as a brake or as a clutch.

Magnetorheological fluids (MRF) are suspensions of magnetically polarisable particles in a carrier liquid, the viscosity and other rheological properties of which can be changed rapidly and reversibly in a magnetic field. They therefore offer an ideal basis for adaptive torque transmission devices (e.g. clutches or brakes), the transmitted torques of which are controlled by the magnetic field. Thus for example in a clutch, the MRF between two plates rotating at different speeds (subsequently also termed device parts) predominantly transmits by shearing action a torque from one plate (drive-side) to the other (driven-side), the consistency of the MRF and hence the transmitted torque being influenced by the strength of the applied magnetic field. If the plate of the driven-side is locked relative to the rotation, a brake is produced with a controllable braking power. Such magnetorheological clutches and brakes are already known. Also MRF, as can be used in the present invention, are already known: patent DE 10 2004 041 650 B4, which is introduced herewith in its entirety in the disclosure of the present invention, shows such magnetorheological fluids.

In a magnetorheological (MR) clutch or brake, the magnetic field is produced by the current in a coil and is guided through the magnetic circuit into the active gap (subsequently also torque transmission gap) in which the MRF is stiffened. Such MR clutches or brakes exert, without current in the coil, a low torque transmission (disengagement of clutch or idling), whilst the torque transmission becomes ever greater with increasing coil current (engagement of clutch or braking). Without coil current, minimum torque transmission is effected by the fluid friction (entrainment moment).

The MR clutches and brakes known from the state of the art produce the magnetic field by means of electromagnets in the form of coils, i.e. their magnetic circuit system contains coils for producing the magnetic flux in the torque transmission gap. Hence it is not possible to produce a desired operating state with high torque transmission without the use of electrical energy, and a good fail-safe behaviour of the clutch or brake is not provided since, in the case of failure of the electrical energy supply in the clutch or brake, only the minimum torque is transmitted.

It is hence the object of the present invention to make available a magnetorheological torque transmission device and also a corresponding torque transmission method, which avoid the disadvantages of the state of the art mentioned in the previous paragraph.

This object is achieved by the magnetorheological torque transmission device according to claim 1 and also by the magnetorheological torque transmission method according to claim 25. The dependent claims respectively describe advantageous embodiments in this respect. Uses according to the invention of a magnetorheological torque transmission device according to the invention can be deduced from claim 24.

The solution to the object according to the invention is based on providing in the magnetic circuit system of the torque transmission device, which is configured to produce the magnetic flux in the torque transmission gap, not only at least one electromagnet (which comprises a coil) but furthermore also at least one permanent magnet. The adjustment of the magnetic operating point (which determines the magnetic basic field when the coil current is switched off) is effected hence in the present invention by the provision at least of one permanent magnet, by the shape and/or arrangement thereof and also advantageously by the additional provision of a non-magnetic insert and also by the shape and/or arrangement thereof. Hence a plurality of electromagnets and/or permanent magnets in the magnetic circuit system is possible.

There is understood in the following by a magnetic circuit system the sum of all individual magnetic circuits or magnetic circuits of the magnetorheological torque transmission device. Likewise this term stands for the sum of all individual components (e.g. for instance coils, permanent magnets, non-magnetic inserts, flux guide elements or yoke parts (e.g. made of iron) . . . ) which belong to the individual magnetic circuits or form them. What is respectively intended, the person skilled in the art will deduce directly from the respective context. There is understood in the following by an individual magnetic circuit (which together with the other magnetic circuits forms the magnetic circuit system) a defined spatial region which is covered by the closed magnetic field lines of a magnetic field producer (permanent magnet or coil). The defined spatial region can thereby be covered also by the closed field lines of a plurality of magnetic field producers (the closed field lines of the plurality of field producers then extend essentially parallel to each other). It is thereby also not precluded that the field lines of a further magnetic field producer, which belongs not to the observed magnetic circuit but to another one, extend in sections likewise in this defined spatial region. The definition of the magnetic circuit hereby relates to a defined operating state of the system (in particular a defined current flow direction in the coil or the coils of the electromagnet or of the electromagnets): it is also not precluded that, in a different operating state, the same spatial arrangement and physical embodiment of the elements forming the system (permanent magnets, electromagnets, non-magnetic inserts, . . . ) form a different magnetic circuit system. Thus for example wording such as “the electromagnet is disposed in a magnetic circuit without the permanent magnet” subsequently means merely that, in one of the two (according to current flow direction in the coil of the electromagnet) possible operating states, the magnetic circuit comprising the electromagnet does not also include the permanent magnet without however ruling out that, in the other operating state, the permanent magnet is likewise included by this magnetic circuit. The term of magnetic circuit also includes all those components or component parts (i.e. for example coil, ferromagnetic housing parts, e.g. configured as yoke parts, non-magnetic elements, . . . ) of the torque transmission device which are covered or are included by said closed field lines of the magnetic field producer.

In a first advantageous embodiment, the magnetic circuit system of the torque transmission device includes, besides the at least one coil and the at least one permanent magnet, in addition also at least one magnetic flux-regulating, non-magnetic insert (a plurality of such inserts can therefore be present).

In a further advantageous embodiment, the torque transmission device according to the invention is constructed such that two essentially separate magnetic circuits (this is described subsequently in more detail) are formed (the magnetic circuit system then comprises these two individual circuits).

An essential aspect in the present invention is hence that, in order to control the torque transmission between the two mutually rotatable device parts of the torque transmission device by means of the MRF, a magnetic field is used which is produced by at least one coil and at least one permanent magnet and also regulated advantageously in addition by at least one non-magnetic insert.

By using a permanent magnet in the magnetic circuit system, a magnetic basic field can be produced even without current in the coil. By means of the additional coil current, the magnetic field, dependent upon the polarity of the current in the coil, can be either weakened or strengthened. By means of the basic field, solely the permanent magnet produces a basic torque without energy use. Hence the torque required for the normal operating state can be specified or a fail-safe behaviour can be ensured for the case where the electrical energy supply fails.

The present invention hence describes MR torque transmission devices which make possible
the adjustment of the magnetic operating point (magnetic flux density in the active MR gap) in a very wide range and in addition
a particularly large variation range of the magnetic flux density in the active MR gap (torque transmission gap).

Hence the torque to be transmitted of the device can be adjusted within a very wide range to a desired value without energy supply, very small minimal torques and at the same time high variability of the torque can be produced by the current in the coil.

For this purpose, the torque transmission device according to the invention contains a magnetic circuit system which contains at least one coil, at least one permanent magnet and also advantageously at least one non-magnetic insert. By selection of the non-magnetic insert or the non-magnetic inserts, the magnetic flux density in the active MR gap, in the case where no current flows in the coil or in the coils, can be adjusted precisely in the desired manner. It is thereby advantageous if the coils and permanent magnets are disposed in different magnetic circuits of the magnetic circuit system. Hence the danger of depolarisation of the permanent magnets by the magnetic field of the coils is avoided.

In a particular embodiment, the MR torque transmission device according to the invention contains at least one coil, two permanent magnets and at least two active MR gaps. A symmetrical arrangement of the coil and of the permanent magnets on one axis is hereby preferred, i.e. the coil is situated between the two permanent magnets. Hence the magnetic flux guidance can be constructed here from three magnetic circuits. In such a magnetic circuit system, the magnetic flux produced by the coil extends essentially through the two active MR gaps and not through the permanent magnets, as a result of which the danger of depolarisation of the permanent magnets is avoided. In addition, the magnetic flux of each of the two permanent magnets extends only through respectively one active MR gap, as a result of which a higher magnetic flux density is produced than when flowing through both active MR gaps.

In the present invention, the active MR gaps or torque transmission gaps can be disposed either parallel to the axis of rotation (axial design corresponding to the bell-shaped configuration known from the state of the art) or perpendicular to the axis of rotation (radial design corresponding to the known disc configuration from the state of the art). Furthermore, also a plurality of individual MR gaps can be disposed parallel to each other in order to increase the transmittable torque due to the larger shear surface (lamellar arrangement of the walls delimiting the gaps). If a torque transmission gap is mentioned subsequently, then there is understood hereby both the total volume of the gap which is filled or can be filled by the MRF, and the individual gap portions (disposed essentially parallel to each other). What is intended respectively, the person skilled in the art deduces directly from the respective context.

Further embodiments of the torque transmission device according to the invention reside in a magnetorheological gel (MRG), a magnetorheological elastomer (MRE) or a magnetorheological foam (MRS) being used as controllable material instead of the MRF. An MRG is a material which is indeed soft, in contrast to an MRF, but is not liquid. Analogously to an MRF, it can be deformed in any way irreversibly and is stiffened in the magnetic field analogously to an MRF. An MRE is a cross-linked material which therefore has a prescribed form from which it can be deformed reversibly only in a limited manner. An MRS is an elastomer foam, the pores of which are filled with an MRF. Like MRE, an MRS also has a prescribed form from which it can be deformed reversibly only in a limited fashion.

Possible applications of the torque transmission device according to the invention are electrically controllable clutches and brakes in which the transmitted torque is changed via the magnetic field produced by the coil or the coils. By means of the permanent magnet or the permanent magnets and the advantageous non-magnetic insert or the non-magnetic inserts, a desired basic torque is thereby adjusted without coil current for a specific operating state or for a fail-safe behaviour.

Further applications are immobiling or locking devices. The locking torque is thereby produced without energy use and eliminated by the coil current. For example safety switches can be produced herewith.

Furthermore, the torque transmission devices according to the invention can also be used for haptic appliances or as man-machine interfaces. A basic torque which can be clearly perceived by the user is thereby produced by the permanent magnet or magnets and is either weakened or strengthened by the electromagnet or electromagnets.

The present invention is explained subsequently in more detail with reference to two embodiments.

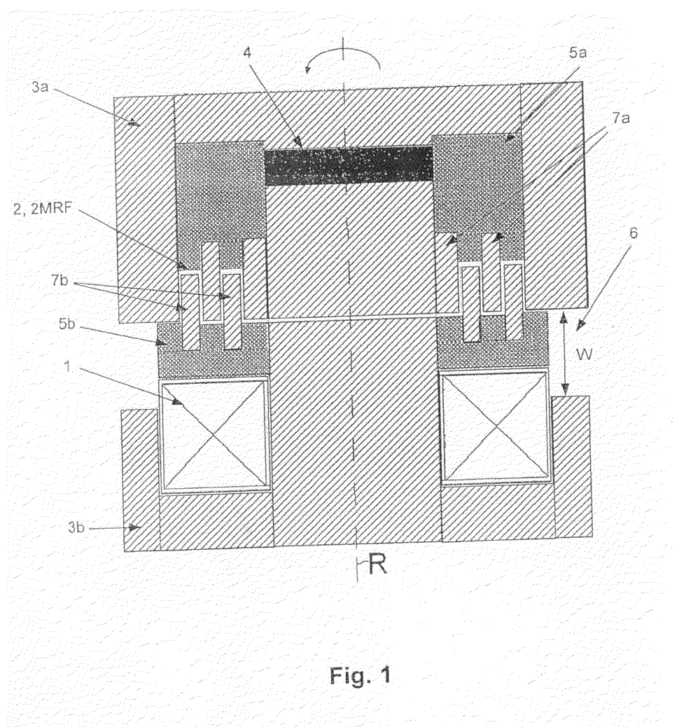

FIG. 1 shows a magnetorheological clutch according to the invention in a sectional view.

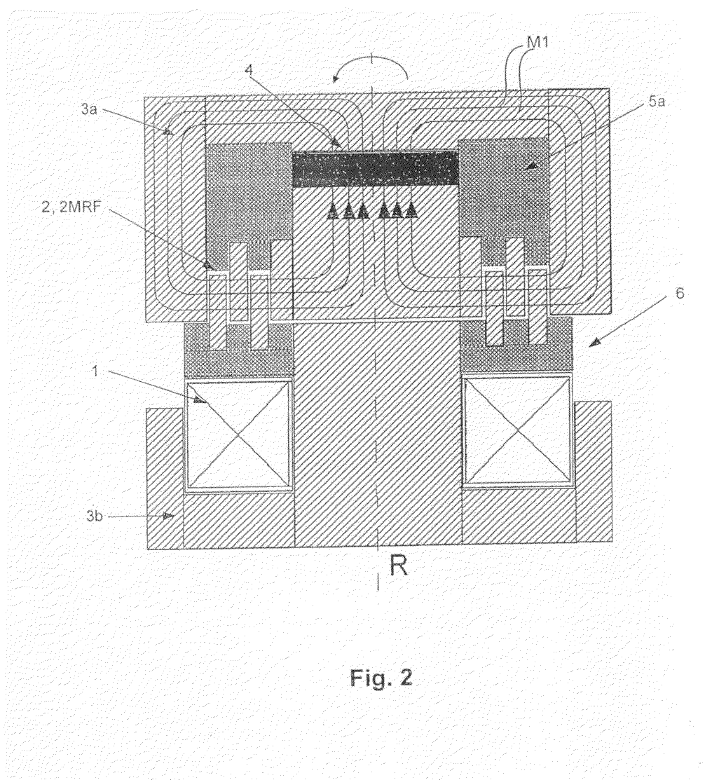

FIG. 2 shows the magnetorheological clutch according to the invention of FIG. 1 with the magnetic field produced by the permanent magnet.

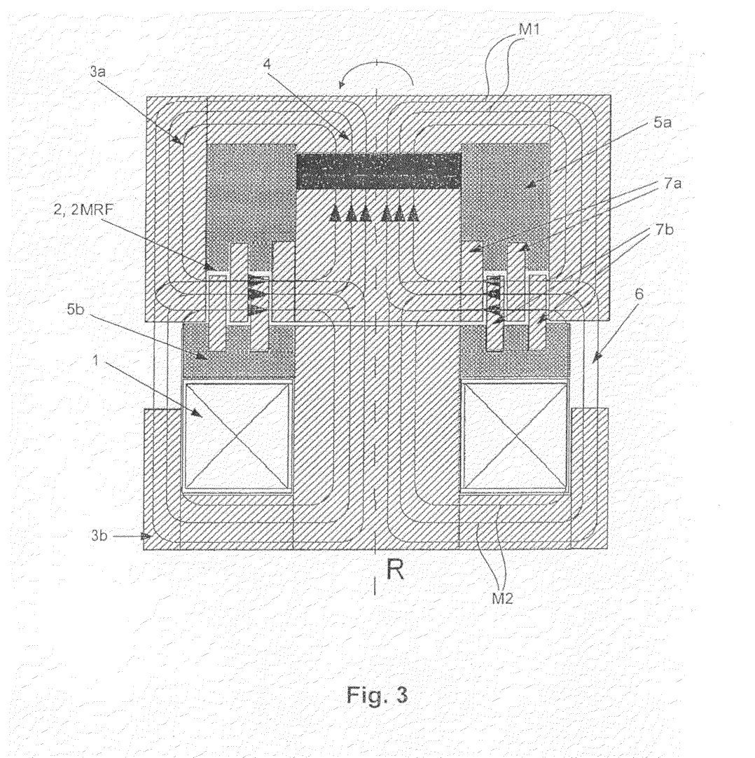

FIG. 3 shows the operation of the magnetorheological clutch according to the invention of FIG. 1 with magnetic field strengthening with the coil.

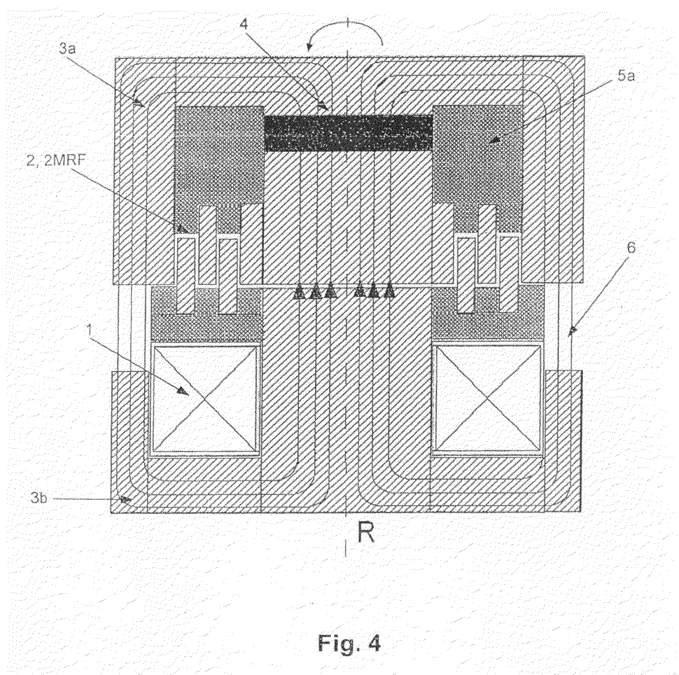

FIG. 4 shows the magnetorheological clutch according to the invention of FIG. 1 in the state of weakening of the flux density by reversing the polarity of the electromagnet.

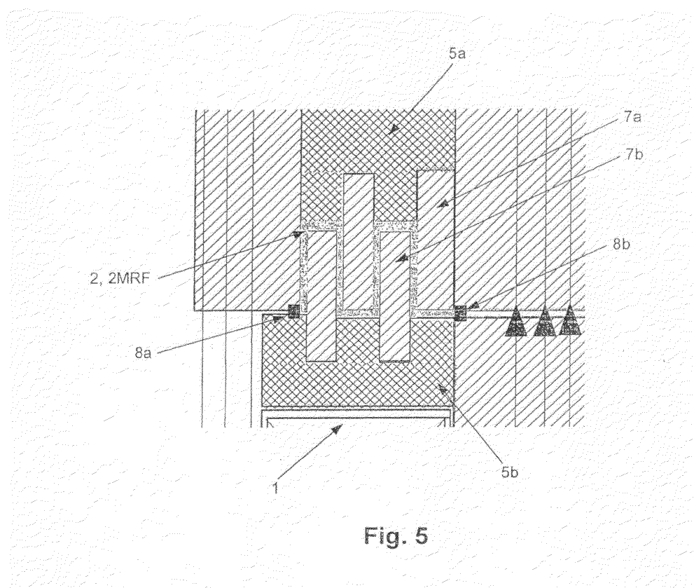

FIG. 5 shows the torque transmission gap of the device according to the invention of FIG. 1 in an enlarged view.

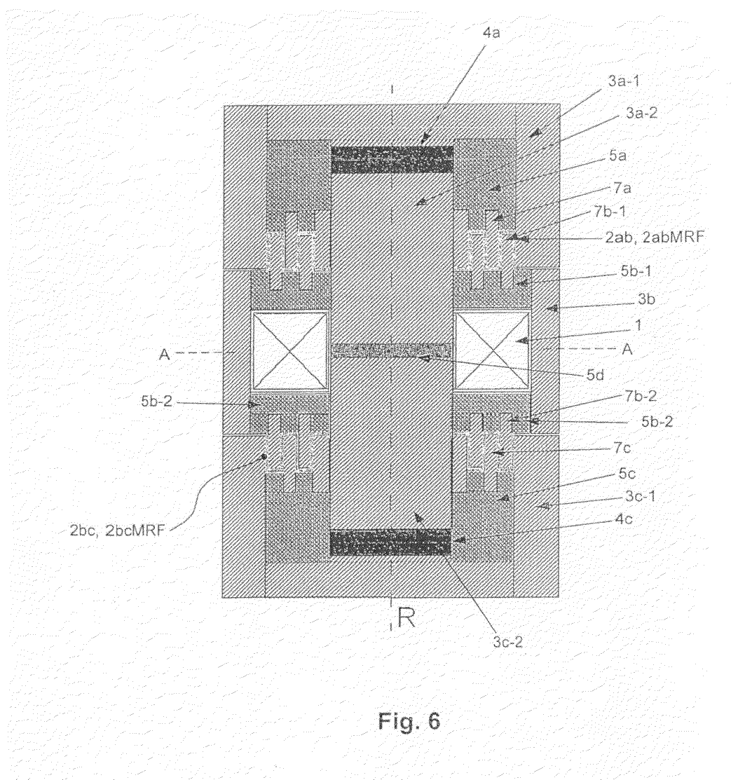

FIG. 6 shows a second magnetorheological clutch according to the invention (symmetrical device) in sectional view.

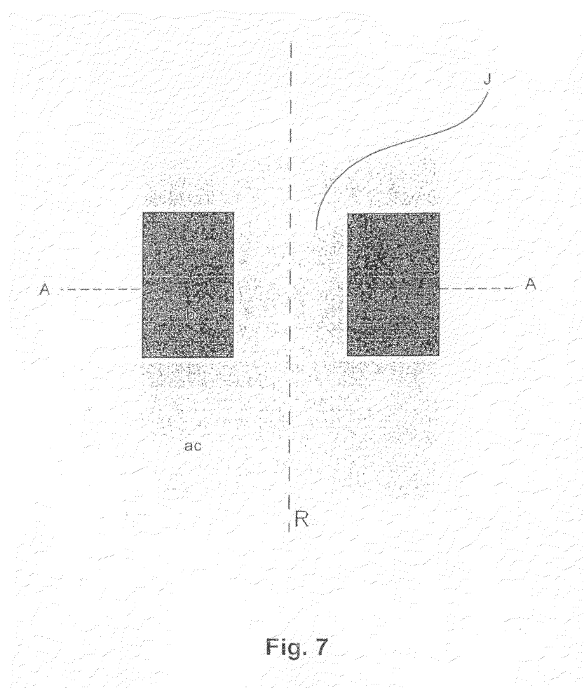

FIG. 7 shows schematically the basic construction of the magnetorheological clutch according to FIG. 6.

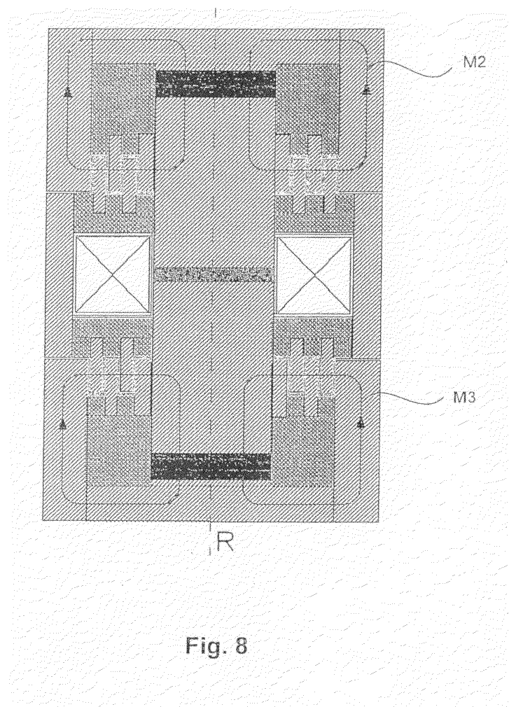

FIG. 8 shows the operation of the magnetorheological clutch according to the invention of FIG. 6 with the magnetic field produced by the permanent magnets.

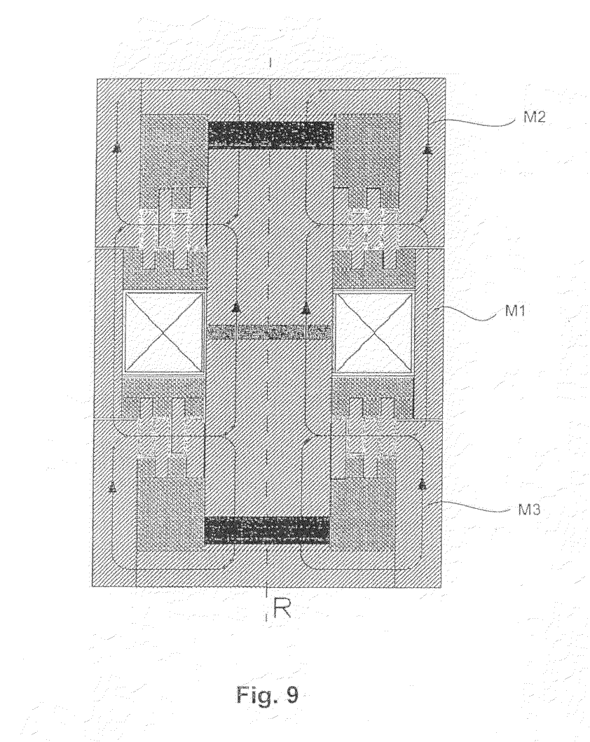

FIG. 9 shows the operation of the magnetorheological clutch according to the invention of FIG. 6 with magnetic field strengthening by the coil.

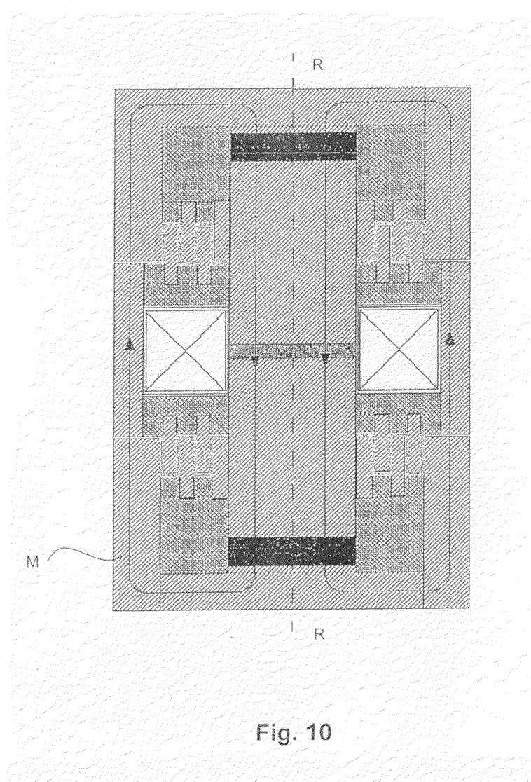

FIG. 10 shows the magnetorheological clutch according to the invention of FIG. 6 in the state of weakening of the flux density by reversing the polarity of the electromagnet.

### EMBODIMENT 1

FIG. 1 shows a magnetorheological clutch according to the invention in a sectional view through the axis of rotation R. The illustrated magnetorheological clutch is constructed rotationally symmetrically about the axis of rotation R. It comprises a first device part or clutch part 3a, 4, 5a, 7a and also a second clutch part 1, 3b, 5b, 6 which is separated there by the torque transmission gap 2 which is filled with an MRF 2MRF. The two clutch parts are constructed as described subsequently in more detail. Both clutch parts are disposed centrally here about the axis of rotation and can be rotated about these mutually or relative to each other.

The first clutch part comprises a housing 3a made of ferromagnetic material. This housing 3a encloses the permanent magnet 4 which is disposed centrally on the axis of rotation R. Said permanent magnet is magnetised here in the axial direction or rotational axis direction. The permanent magnet 4 is surrounded radially (i.e. at its outer circumference) by a non-magnetic insert 5a which is surrounded likewise by the housing 3a. The non-magnetic insert 5a is configured here as a three-dimensional, fixed moulded article. The non-magnetic insert here comprises an aluminium hollow body filled with air (saving in weight) but it can also comprise entirely aluminium, any type of plastic material and/or stainless steel or have these materials or any combinations thereof. With a suitable constructional configuration (so that e.g. the mounting of the elements 7a is ensured), the insert can also entirely consist of air.

On the side orientated towards the second clutch part, a plurality of lamellae made of ferromagnetic material 7a are integrated in the moulded article 5a. These lamellae 7a are disposed at a radial spacing from the axis of rotation R centrally about the latter, hence because of the rotational symmetry of the arrangement are configured as thin-wall hollow cylinders, the walls of which extend parallel to the axis of rotation R. Because of their zip-like engagement in each other, these lamellae made of ferromagnetic material 7a form together with their counterparts 7b (see subsequently) of the second clutch part the MR gap, which is filled with the magnetorheological fluid 2MRF, or torque transmission gap 2 between the two clutch parts. The torque transmission gap hence extends, in the illustrated section observed through the axis of rotation, in a meandering shape, the active MR gap portions (i.e. those in which the magnetic field lines from the adjacent walls of the ferromagnetic materials 7a, 7b run vertically) extend parallel to the axis of rotation R. The magnetorheological clutch is hence configured in a bell-shaped configuration or in an axial design.

The second clutch part which is disposed adjacent to the first clutch part on the other side of the MR gap 2 likewise has a housing part 3b made of ferromagnetic material. In this housing part 3b, the coil 1 of the electromagnet is embedded, extending radially at a spacing relative to the axis of rotation R. The electromagnet is hence disposed in the form of a hollow cylinder which is cuboid in cross-section and the axis of symmetry of which coincides with the axis of rotation. On the side of the second clutch part orientated towards the gap, further non-magnetic moulded articles 5b, made of the same material as the moulded articles 5a of the first clutch part, are disposed adjacent to the coil 1. In these, the above-described lamellar counterparts 7b made of ferromagnetic material are embedded. These are likewise configured like the lamellar elements 7a of the first clutch part and disposed such that they engage in the lamellar arrangement 7a in the manner of a zip. On the side orientated towards the MRF gap 2, the second clutch part, on the circumference, has a recess 6 which extends at a radial spacing relative to the axis of rotation R (air gap or control gap). This has the width w in the axis of rotation direction. By choice of this width w, adjustment of the currentless operating point of the magnetorheological clutch can be chosen. This air gap also serves for separation of the clutch sides.

In the present case, the second clutch part (the one situated at the bottom in the illustrated Figure) represents the drive-side. If this rotates, then it transmits, with a sufficiently high magnetic field strength with which the MRF 2MRF stiffens in the gap 2, a torque to the driven-side (first clutch part). The precise mode of operation of the torque transmission is hereby known to the person skilled in the art. It is likewise known to the person skilled in the art that the illustrated device can also be configured or can be used as a brake. The clutch/brake is hence divided into two parts by the torque transmission gap 2, one part being stationary (brake) or both parts rotating with different speeds about the axis of rotation R (clutch), according to the mode of operation.

FIG. 2 now shows the magnetic circuit system of the magnetorheological clutch according to the invention of FIG. 1 in operating mode only with the permanent magnet 4 (i.e. without coil current). A magnetic field (field lines M1) is present only in the first magnetic circuit in this operating mode. The first magnetic circuit hereby comprises the ferromagnetic housing 3a of the first clutch part, the permanent magnet 4, the lamellar arrangement 7 and also the first moulded article 5a surrounded by the magnetic field lines of the permanent magnet or it covers these components with its closed field lines or surrounds them. In the present case, the moulded article 5a is disposed radially on the circumference of the permanent magnet 4. In an alternative variant, the moulded article 5a and the permanent magnet 4 can however also be configured such that the non-magnetic moulded article is situated in the permanent magnet or is surrounded by the latter.

Because of the non-magnetic bell-shaped mounting 5a and the control air gap 6, the magnetic flux of the permanent magnet 4 is guided through the torque transmission gap 2. A substantial advantage of this geometric arrangement is that, by means of the air gap 6 which serves here like the moulded article 5a, 5b as a non-magnetic insert, a relatively high torque can be produced merely by the permanent magnet 4 alone. This currentless operating point can be preadjusted by the air gap width w. It is a further advantage that the permanent magnet 4, due to the separation of the two magnetic circuits (first magnetic circuit shown here with the magnetic field lines M1, second magnetic circuit see subsequently), is not flooded counter to its magnetisation direction and hence is not weakened irreversibly. The separation of the two magnetic circuits here is effected in that the permanent magnet 4 and the coil 1, observed in the axis of rotation direction R, are disposed at a spacing from each other and in the different clutch parts.

FIG. 3 now shows in addition the second magnetic circuit (magnetic field lines M2) which is formed by the coil 1, the moulded article 5b, the housing portion 3b of the second clutch part and also the lamellar arrangements 7a and 7b or which includes or covers these elements. By switching on the current of the coil, the magnetic field in the MRF gap can hence be increased. Care must hereby be taken that the magnetic field has the correct orientation, the current direction in the coil 1 is therefore chosen such that, in the region of the torque transmission gap 2, the magnetic field lines M1 of the first magnetic circuit and the magnetic field lines M2 of the second magnetic circuit are superimposed cumulatively. Otherwise the result is weakening of the flux density in the torque transmission gap 2 (see illustration 4). The air gap width w must be adjusted such that, with the help of the electromagnet (as shown in the current direction in the electromagnet or in the coil 1), weakening to a torque close to the entrainment moment is possible (idling moment without magnetic field in the magnetorheological fluid 2 MRF).

FIG. 4 shows the magnetic field line course when the current direction in the coil 1 is chosen in the opposite direction to that shown in FIG. 3 (reversal of polarity of the electromagnet).

FIG. 5 shows a section of the torque transmission gap 2 of FIG. 1 in enlargement. The course of the torque transmission gap 2 which is in a meandering shape in section and is produced by the lamellar arrangements 7a, 7b of the two clutch parts which engage in each other in the manner of a zip can be readily seen. The torque transmission gap 2 is filled here entirely with the MRF 2MRF (shaded regions). In order to prevent leakage of the MRF in the stationary state and/or in rotation, the torque transmission gap portion filled with the MRF is provided, both on the side orientated towards the axis of rotation R and on the opposite side orientated away therefrom respectively, with sealing elements 8a, 8b.

### EMBODIMENT 2

FIG. 6 shows a symmetrically constructed magnetorheological torque transmission device which has an electromagnet and two permanent magnets. There is intended here by symmetrical that the illustrated device is not only symmetrical about the axis of rotation R but also mirror-symmetrical relative to the plane A-A which intersects the device perpendicular to the axis of rotation R at half height.

The first device part (subsequently also termed outer part) is, in the illustrated section, double-T-shaped (see also FIG. 7) and comprises an upper outer part and a lower outer part. The upper outer part has the elements 3a-1, 3a-2, 4a, 5a, 7a, which are described subsequently in even more detail, and also the portion of the element 5d situated above the plane A-A. The lower outer part of the outer part has the elements 3c-1, 3c-2, 4c, 5c, 7c, which are likewise described subsequently in even more detail, and the portion of the element 5d situated below the plane A-A.

In the illustrated case, the outer part represents the driven-side, the central part which is described subsequently in even more detail is then configured as drive-device part (clutch). It is however also possible to operate the outer part as drive-side and the central part as driven-side. In the case of the configuration as a brake, it is possible to operate the outer part as the device part to be braked (standstill) and the central part as a part disposed in a stationary manner relative to the surroundings. A reverse operation is also possible.

As FIG. 7 also shows schematically, the magnetorheological torque transmission device (clutch or brake) is hence subdivided into two device parts, the outer part ac and the central part b. The central part b is hereby separated from the outer part ac, as described subsequently in even more detail, by the MRF gap and possibly further gap portions (in which the two parts b and ac abut against each other in a form fit but are not connected to each other) and can be rotated relative to the latter about the axis of rotation R. The central part b is disposed on the outer circumference of the yoke portion J of the double-T-shaped outer part at a spacing from the axis of rotation R.

The upper portion of the outer part (or the upper outer part) has a first ferromagnetic housing portion 3a-1 which, like the housing portion 3a shown in FIG. 1, includes the upper outer part on the outer side. Therein (as already in the case shown in FIG. 1), the non-magnetic insert 5a, the permanent magnet 4a and also the lamellar arrangement 7a are disposed. The yoke portion J of the upper outer part is configured by a further ferromagnetic housing part 3a-2 which extends along the axis R from the underside of the permanent magnet 4a until it abuts against a further non-magnetic insert 5d (subsequently also termed non-magnetic break). The non-magnetic break 5d is disposed mirror-symmetrically relative to the plane A-A, i.e. such that its upper half which is orientated towards the upper outer part is situated above the plane A-A and its lower half which is orientated towards the lower outer part is situated below this plane A-A. The ferromagnetic housing part 3a-2 is hence disposed concentrically about the axis of rotation R within the non-magnetic insert 5a and the lamellar arrangement 7a.

The lower outer part is constructed just like the upper outer part (ferromagnetic housing parts 3c-1 and 3c-2, permanent magnet 4c, non-magnetic insert 5c and also lamellar arrangement 7c and lower portion of the element 5d) but disposed below the plane A-A mirror-symmetrically relative to the upper outer part.

The central part which can be rotated relative to the outer part about the axis of rotation R has, on the outer circumference, the housing portion 3b made of a ferromagnetic material in the form of a circumferential hollow cylinder at a spacing from the axis of rotation R. Within this wall portion 3b and outwith the yoke portion J of the outer part, there is disposed, mirror-symmetrically relative to the plane A-A and hence at the height of the non-magnetic break 5d, the coil 1 of the electromagnet. Above the coil 1 and hence at a spacing from the plane A-A, the non-magnetic insert 5b-1 is positioned, in which the lamellar arrangement 7b-1 is disposed. On the oppositely situated side which is orientated towards the lower outer part, correspondingly at a spacing from the plane A-A, the non-magnetic insert 5b-2 in which the lamellar arrangement 7b-2 is disposed in engagement is accommodated. As was explained already with respect to FIG. 1, the lamellar portions 7b-1 engage in the manner of a zip in the lamellar portions 7a of the upper outer part. The same applies for engagement of the lamellar portions 7b-2 in the lamellar portions 7c of the lower outer part.

Between the lamellar portions 7a and 7b-1, the first torque transmission gap 2a, 2b extends in a meandering shape between the upper outer part and the central part. Likewise, between the lower outer part and the central part, the second torque transmission gap 2bc extends in a meandering shape between the lamellar arrangements 7b-2 and 7c. The first torque transmission gap is filled with a magnetorheological fluid 2abMRF, the second corresponding to the MRF 2bcMRF. The two MRF gaps 2ab and 2bc here have a connection (not shown) so that it is possible to fill these gaps in common with the MRF.

The torque transmission device shown in FIG. 6 hence represents a symmetrically modified version of the torque transmission device shown in FIG. 1. A substantial advantage of this arrangement is the doubled number of MRF gaps (two gaps 2ab and 2bc) and the addition of a further permanent magnet (two permanent magnets 4a and 4c) and also the displacement of the non-magnetic break 5d into the centre of the yoke portion J (observed with respect to the plane A-A). The two permanent magnets here necessarily have the same axial magnetisation direction (parallel to the axis of rotation direction R), directed here for example upwards, i.e. from the lower outer part towards the upper outer part. This is necessary since the two permanent magnets would otherwise be weakened mutually. In order that a magnetic connection is possible over the two MRF gaps, the non-magnetic break 5d must sit between the two permanent magnets 4a and 4b. Observed in the axis of rotation direction R, the following elements are hence disposed along the axis of rotation R and symmetrically about the latter: permanent magnet 4a, coil 1 together with non-magnetic break 5d and permanent magnet 4b. As a result of the thickness of the non-magnetic break 5d in the direction of the axis R (i.e. perpendicular to the plane A-A), the magnetic operating point of the torque transmission device can be adjusted in the desired manner.

If the illustrated torque transmission device is configured as a brake, then one of the two device parts is disposed rigidly. Preferably, this is the central part since thus the coil 1 is permanently situated in an unmoved state relative to the surroundings. If the shown torque transmission device is configured as a clutch, then a part of the arrangement (preferably the central part) forms the drive-side, the other the driven-side. In both cases, the two device parts can rotate relative to each other about the axis of rotation R.

FIG. 8 shows the torque transmission device of FIG. 6 in operating mode, in which a magnetic flux is produced merely by the two permanent magnets 4a and 4c: in this case, a first magnetic circuit is configured by the permanent magnet 4a (magnetic field lines M2) via the elements 3a-1, 3a-2, 5a, 7a and 7b-1 and produces a magnetic field in the gap 2ab in the magnetorheological fluid 2abMRF. Likewise, a second magnetic circuit (magnetic field lines M3) which comprises the elements 3c-1, 3c-2, 5c, 7b-2 and 7c and configures a magnetic field in the gap 2bc in the MRF 2bcMRF is configured by the permanent magnet 4c. The illustrated field line direction is produced in that the two permanent magnets have the same magnetic direction of orientation in order not to be mutually weakened or demagnetised. In contrast to the asymmetrical variant (FIG. 1), the non-magnetic break 5d, observed with respect to the axis R, sits within the coil 1 and not (like the corresponding air gap 6 in FIG. 1) outside on the coil. The non-magnetic break 5d is absolutely necessary since only thus is guidance of the magnetic flux over the permanent magnets or separation of the magnetic circuits of the magnetic circuit system possible. The two permanent magnets 4a and 4c hence produce a currentless basic torque. For better clarity, the reference numbers of the components have been left out here in FIG. 8, as also in the two subsequent Figures.

FIG. 9 shows the torque transmission device according to FIG. 6 in the operating mode of strengthening when the magnetic field of the electromagnet is switched on. In this case, a third magnetic circuit (magnetic field lines M1) is configured by the current flow in the coil 1, said third magnetic circuit comprising the elements 3b, 5b-1, 5b-2, 3a-2, 3c-2, 7a, 7b-1, 7b-2 and 7c and hence cumulatively superimposing the magnetic field produced by the permanent magnet in the two gaps. FIG. 9 hence shows the torque transmission device in strengthening mode. The magnetic field which is produced by the coil is added to the magnetic field present due to the permanent magnet. This magnetic field addition functions only if, as described above, the two permanent magnets have the same magnetic preferential direction, since otherwise one permanent magnet would be strengthened and one would be weakened, i.e. it would in total hardly provide a change. Over the thickness of the non-magnetic break 5d, the strength of the magnetic field of the coil can be influenced (as a result of the non-magnetic insert 5d, the inductance thereof is reduced). An exact design of the central part, in particular with respect to the element 5d, is therefore essential.

FIG. 10 shows the torque transmission device according to FIG. 6 in the operating mode of weakening: if the magnetic field which is produced by the coil 1 is reversed in polarity, then the magnetic flux (magnetic field lines M) which is produced by the permanent magnets 4a and 4c is forced out of the MRF gaps 2ab and 2bc. The magnetic flux is now closed over the outer yoke (housing parts 3a-1, 3b and 3c-1) of the arrangement. If the non-magnetic arrangement 5d is designed correctly in the centre between the coil 1, then weakening of the flux density to almost 0 Tesla is possible.

1-27. (canceled)

28. A magnetorheological torque transmission device, having two device parts which are separated by at least one torque transmission gap, which can be filled and/or is filled at least partially with a magnetorheological material, and can be rotated relative to each other about an axis of rotation, wherein the magnetic circuit system of the torque transmission device, which system is configured to produce the magnetic flux in the torque transmission gap, includes, in addition to at least one electromagnet, at least two permanent magnets.

29. A magnetorheological torque transmission device, having two device parts which are separated by at least one torque transmission gap, which can be filled and/or is filled at least partially with a magnetorheological material, and can be rotated relative to each other about an axis of rotation, wherein the magnetic circuit system of the torque transmission device, which system is configured to produce the magnetic flux in the torque transmission gap, includes, in addition to at least one permanent magnet, at least two electromagnets.

30. The magnetorheological torque transmission device according to claim 28, wherein the magnetic circuit system includes in addition at least one non-magnetic insert.

31. The magnetorheological torque transmission device according to claim 30, wherein the non-magnetic insert is comprised of a three-dimensional solid body and/or an air-filled volume.

32. The magnetorheological torque transmission device according to claim 28, wherein the magnetic circuit system of the torque transmission device has at least two magnetic circuits, a first and a second magnetic circuit, an electromagnet being disposed in the second magnetic circuit and a permanent magnet being disposed in the first magnetic circuit.

33. The magnetorheological torque transmission device according to claim 32, wherein the electromagnet, the permanent magnet and/or at least one non-magnetic insert are configured and/or positioned spatially such that the second magnetic flux produced by the electromagnet leads through the second magnetic circuit and preferably not through the permanent magnet and in that the first magnetic flux produced by the permanent magnet leads through the first magnetic circuit and in that the first and the second flux lead through the torque transmission gap.

34. The magnetorheological torque transmission device according to claim 32, wherein at least one electromagnet is disposed in a magnetic circuit without a permanent magnet and in that at least one permanent magnet is disposed in a magnetic circuit without an electromagnet.

35. The magnetorheological torque transmission device according to claim 32, wherein only electromagnets are disposed in the second magnetic circuit and only permanent magnets are disposed in the first magnetic circuit.

36. The magnetorheological torque transmission device according to claim 32, wherein an electromagnet and a permanent magnet are disposed in neither of the magnetic circuits at the same time.

37. The magnetorheological torque transmission device according to claim 32, wherein the second magnetic circuit comprises an electromagnet and a non-magnetic insert and/or in that the first magnetic circuit comprises a permanent magnet and a non-magnetic insert.

38. The magnetorheological torque transmission device according to claim 28, wherein a permanent magnet and an electromagnet are disposed at a spacing from each other, observed in the axis of rotation direction.

39. The magnetorheological torque transmission device according to claim 28, wherein a permanent magnet is disposed centrally on the axis of rotation and/or in that an electromagnet is disposed at a radial spacing from and radially symmetrically about the axis of rotation.

40. The magnetorheological torque transmission device according to claim 28, wherein the torque transmission gap is disposed essentially parallel to the axis of rotation in an axial or bell-shaped configuration or in that the torque transmission gap is disposed essentially perpendicular to the axis of rotation in a radial or disc configuration.

41. The magnetorheological torque transmission device according to claim 28, wherein a plurality of torque transmission gaps are disposed in particular essentially parallel to each other.

42. The magnetorheological torque transmission device according to claim 28, wherein the electromagnet and the two permanent magnets are disposed at a spacing from each other and along the axis of rotation and also rotationally symmetrically about the latter, the electromagnet being disposed between the two permanent magnets.

43. The magnetorheological torque transmission device according to claim 28, wherein the magnetic circuit system comprises at least one electromagnet and at least two permanent magnets or at least two electromagnets and at least one permanent magnet, and also at least two torque transmission gaps which are disposed essentially parallel to each other and also have a connection to each other.

44. The magnetorheological torque transmission device according to claim 43, wherein the electromagnet and/or the two permanent magnets or the permanent magnet and/or the two electromagnets and/or at least one non-magnetic insert are configured and/or positioned spatially such that the magnetic flux produced by the electromagnet or the electromagnets leads through both torque transmission gaps, but through no permanent magnet and/or in that the magnetic flux produced by one of the two permanent magnets respectively only leads through precisely one of the two torque transmission gaps.

45. The magnetorheological torque transmission device according to claim 28, wherein the magnetic circuit system comprises 2S−1 electromagnets (S=1, 2, 3, . . . ) and 2P permanent magnets (P=1, 2, 3, . . . ) or 2S electromagnets (S=1, 2, 3, . . . ) and 2P−1 permanent magnets (P=1, 2, 3, . . . ), and P=S.

46. The magnetorheological torque transmission device according to claim 28, wherein a non-magnetic insert which is disposed preferably between the two permanent magnets and/or, observed from the axis of rotation, concentrically about the latter and within the electromagnet.

47. The magnetorheological torque transmission device according to claim 28, wherein the electromagnet comprises a coil.

48. The magnetorheological torque transmission device according to claim 28, wherein a permanent magnet contains and/or comprises at least one of the subsequent hard magnetic materials: NdFeB, an alloy containing Sm and Co, an alloy containing Al, Ni and Co, ferrites.

49. The magnetorheological torque transmission device according to claim 28, wherein the magnetorheological material contains and/or comprises a magnetorheological fluid, a magnetorheological gel, a magnetorheological elastomer and/or a magnetorheological foam.

50. The magnetorheological torque transmission device according to claim 28, configured as a clutch, brake, immobilizing or locking device, safety switch, haptic appliance or as a man-machine interface element.

51. A magnetorheological torque transmission method, wherein two device parts which are separated by at least one torque transmission gap which is filled at least partially with a magnetorheological material are rotated relative to each other about an axis of rotation, wherein the magnetic flux in the torque transmission gap is produced by means of at least one coil, which is subjected to a flow of current, and at least two permanent magnets.

52. A magnetorheological torque transmission method, wherein two device parts which are separated by at least one torque transmission gap which is filled at least partially with a magnetorheological material are rotated relative to each other about an axis of rotation, wherein the magnetic flux in the torque transmission gap is produced by means of at least two coils, which are subjected to a flow of current, and at least one permanent magnet.

53. The magnetorheological torque transmission method according to claim 51, wherein the magnetic flux in the torque transmission gap is pre-adjusted by means of a non-magnetic insert.
